(19) United States
(12) Patent Application Publication
(10) Pub. No.: US 2005/0265531 A1
(43) Pub. Date: Dec. 1, 2005

(54) Device management system and method

(75) Inventor: Naula Mika, Oulu (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/858,680

(22) Filed: Jun. 1, 2004

(51) Int. Cl. H04M 3/42

(52) U.S. Cl. 379/201.01

(57) ABSTRACT

Embodiments of the present invention include device, methods, and computer code products which allow a user to customize the features which will be available after boot up of a device. The various embodiments can include a profile module adapted to store profiles and a startup management configured to start background processes during boot up of a device based on features specified the stored profiles.

### BACKGROUND OF THE INVENTION

The present invention relates generally to the field of electronic device, and particularly to systems and methods of managing components capable of operating on the electronic device.

Current electronic devices, such as mobile or cellular phones, generally include a variety of capabilities or features which run in the background in order to make those capabilities and features available when a user requests them. Thus, for example, a mobile phone may be provided with the capability of communicating with another device through an infrared data port. The software required for this communication may be enabled through a background process running on a processor in the mobile phone. Thus, the background process must be started even if a user may rarely use this feature.

Such background processes are typically started during the booting up of the device. For example, when a user turns on the power in a mobile phone, the processor starts a series of background processes to enable all features of the mobile phone. A starter server component in the mobile phone may have a static list of components, all of which are started every time the device is booted up. As the number of such components and the complexity of the devices increases, more and more components are needed to start during boot up, resulting in a significant increase in boot-up time.

In existing devices, the static list of components is generally configured to support every boot-up for every user. Thus, the list generally includes all features and capabilities available on the device. From a user's perspective, however, there are too many components on this list, many of which are rarely, if ever, used by the user.

### SUMMARY OF THE INVENTION

One embodiment of the invention relates to an electronic device. The device includes a profiles module adapted to store one or more profiles, each of the profiles being indicative of a set of features, at least one of the profiles being customizable by a user and having at least one feature being a service associated with a background process. In a particular embodiment, the device includes a startup manager adapted to start a set of background processes during a boot up of the device, the set of background processes corresponding to the set of features of a selected one of the profiles

In another embodiment, a method of managing an electronic device is provided. The method includes accessing a selected profile in a profile module having one or more profiles therein, each of the profiles being indicative of a set of features, at least one of the profiles being customizable by a user and having at least one feature being a service associated with a background process, and starting a set of background processes during a boot up of a device, the set of background processes corresponding to the set of features of the selected profile.

In another embodiment, a method of managing an electronic device includes storing a profile in a profiles module, the profile being indicative of a set of user-selected features, at least one of the features being a service associated with a background process, and starting a set of background processes during a boot up of a device, the set of background processes corresponding to the set of features of the stored profile.

In another embodiment, a method of managing an electronic device includes presenting a set of features to a user, at least one of the features being customizable by a user and being a service associated with a background process. The method further includes receiving inputs from a user, the inputs being associated with a selection or deselection of one or more of the features.

The following description of certain embodiments serves to explain the invention in greater detail in conjunction with the drawings.

### BRIEF DESCRIPTION OF THE DRAWINGS

FIG. 1 is a schematic illustration of an architecture of a system according to an embodiment of the invention;

FIG. 2 is a schematic illustration of certain sub-modules of the common components module of FIG. 1;

FIG. 3 is a schematic illustration of an embodiment of a profile management architecture;

FIG. 4 illustrates a profile table according to an embodiment of the invention; and

FIGS. 5 and 6 illustrate a profile management interface according to an embodiment of the invention.

### DETAILED DESCRIPTION OF THE PREFERRED EMBODIMENTS

As describe above, existing systems require a device to start background processes from a static list to enable a set of features, which generally includes all features available on the device. “Features” include non-telephony services such as wireless local area network (WLAN) capability, Bluetooth, Global Positioning System (GPS) and others that may be available on electronic devices such as mobile phones. Many of these features may be rarely, or never, required by a particular user. For example, a mobile phone may be provided with features which allow the phone to communicate with other devices through, for example, an infrared data port. The primary user for that mobile phone may never have the need for such a feature. Other services may be desirable at certain times, but not at others. Thus, the starting of the background process to enable that feature each time unnecessarily increases the boot-up time for that device.

Embodiments of the present invention provide systems and methods which allow a user to customize the features which will be available after a boot up. In this regard, functionality is provided to allow the user to select or deselect features, services and/or background processes by manipulating or selecting a profile. Thus, a user can select which features will be available on the device. Background processes for those features which are not selected by the user are not started during the boot up, thereby reducing the boot-up time and power consumption, while increasing available memory. It is important to note that the features which are not selected are still available on the device for future use. To access those features in the future, a user can activate them by selecting a proper profile. Since the device automatically uses the last active profile when booting up, the desired set of features are activated during boot up.

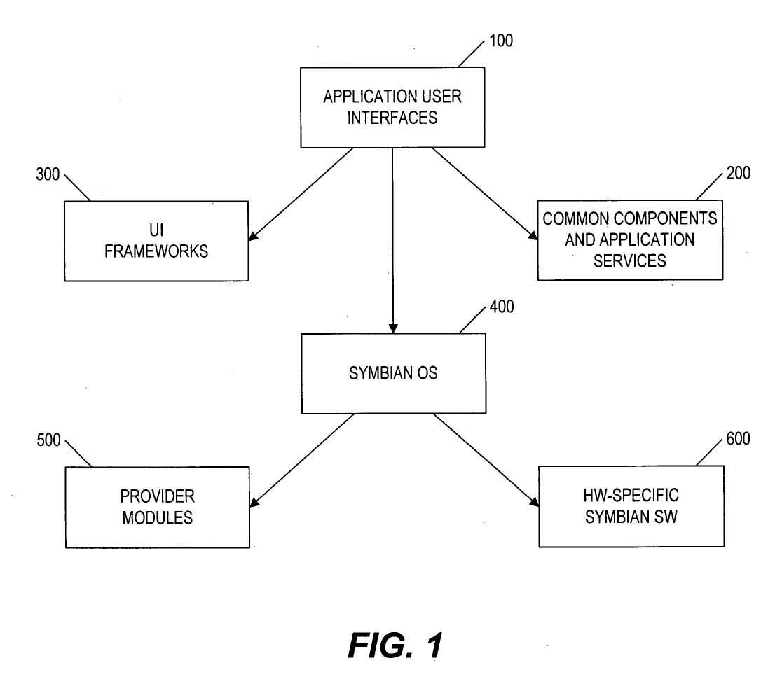

FIG. 1 illustrates an architecture of a system according to an embodiment of the invention. The system includes an application user interfaces module 100 which includes user-interface (UI) components. Such UI components may be customized for different user-interface sizes and styles, as may be required for different devices. For example, one set of UI components may be provided for use on a mobile phone with a small display area, while a second set of UI components may be provided for use on a hand-held personal digital assistant (PDA) with a larger display. The set of UI components may include applications, application views or application controls. A UI component may be used either by a single application or, in some cases, by a plurality of applications.

The system also includes a common components and application services module 200. This module 200 provides services primarily for use by application engines. Such services may include an alarm server, a logging engine, a system-wide task scheduler, a system agent, and converters between various data and standards formats. Further, the common components and application services module 200 may include an Application Program Interface (API) to support various applications.

A User Interface (UI) Frameworks module 300 is provided to support various user interfaces for the device. This module 300 may include software to support the framework and graphics for the user interfaces associated with the various applications on the device.

The system implements an operating system 400 which interfaces with various applications running on the device. In the illustrated embodiment, the operating system is the Symbian operating system that is commonly employed in many wireless and handheld devices. For more information on the Symbian operating system, reference may be made to www.symbian.com. The operating system 400 includes fundamental base services for a device, including various services, libraries, protocols and frameworks.

The operating system 400 is linked to a set of provider modules 500. Provider modules 500 may include files, libraries, documents or other software that is associated with applications external to the operating system 400. Additionally, a software module 600 may be accessed by the operating system 400 to support the specific hardware of the device. Thus, the operating system 400 may be provided to support a generic device, while the software module 600 provides supplemental functionality to support the specific device.

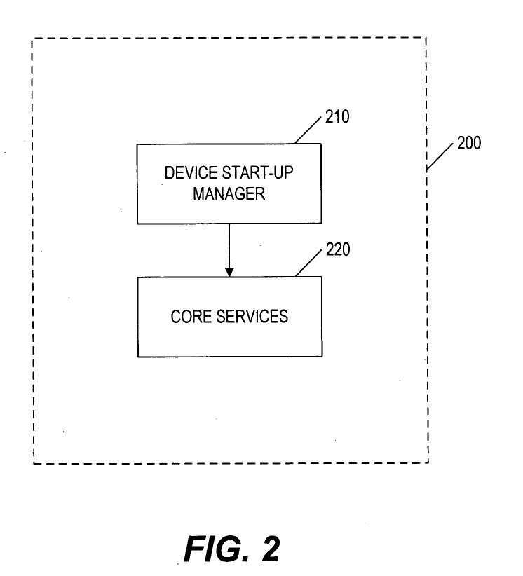

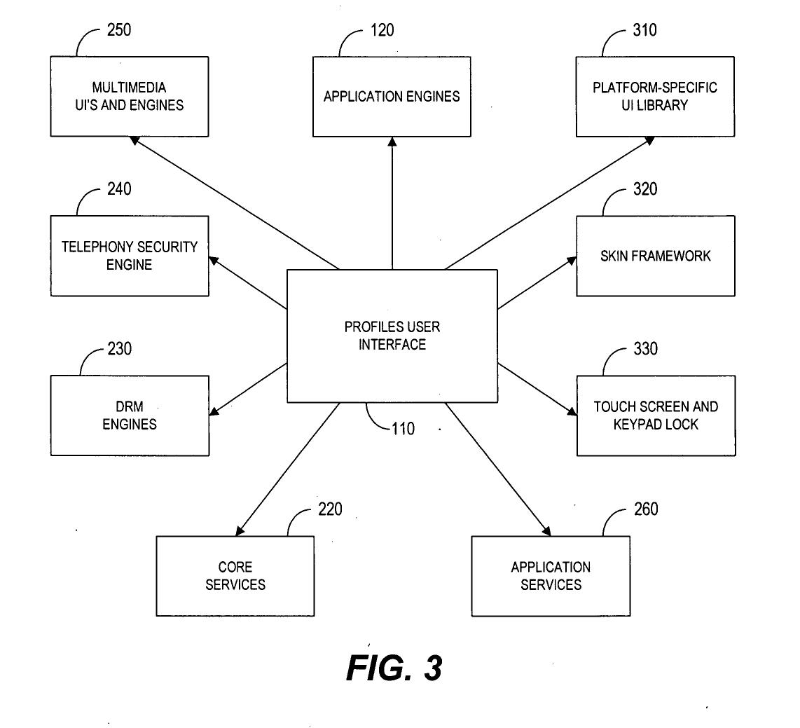

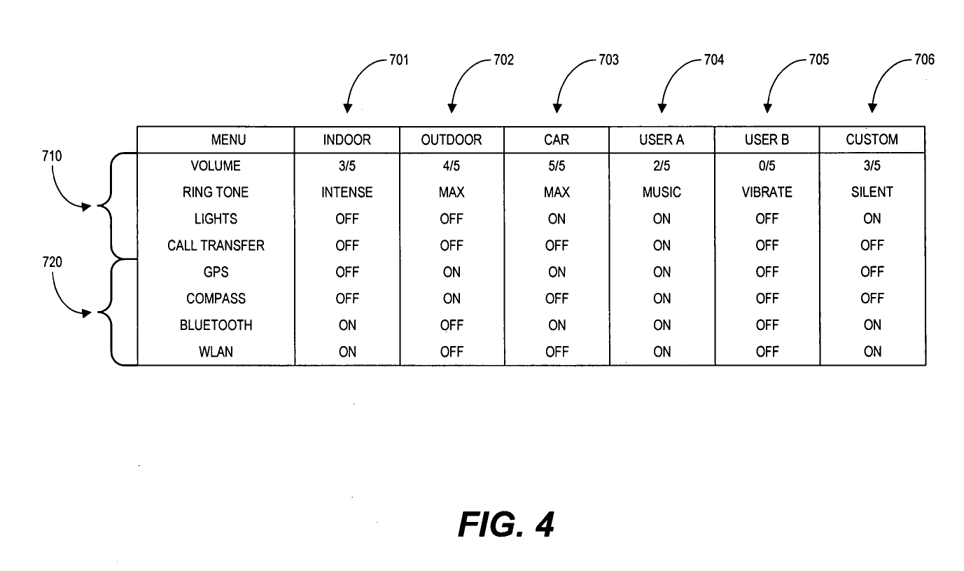

FIG. 2 is a schematic illustration of the common components and application services module 200 of FIG. 1 with some of the sub-modules shown. In particular, the common components and application services module 200 includes a device start-up manager 210 and a core services module 220. The device start-up manager 210 is provided to manage the start-up, or boot up, of the device. In particular, the device start-up manager 210 is adapted to determine which background processes need to be started during boot up. In this regard, the device start-up manager 210 accesses a profiles module which stores one or more profiles. The profiles module may be integrated within the device start-up manager 210 or may be implemented in another module, as described below with reference to FIG. 3. The profiles in the profiles module indicate a list of features or a list of background processes to be started at boot up. Additionally, each profile specifies a plurality of user-adjustable operating characteristics, such as volume or ring tones. Each profile may be different, and at least one of the profiles is customizable by a user such that one or more features or background processes may be selected or deselected to be available, as described below with reference to FIGS. 4-6.

The device start-up manager 210 is adapted to communicate the background processes to be started during boot up to the core services module 220. The core services module 220 includes general engines, such as for finding items, link or files stored in the device. The core services module 220 is provided to manage the settings and initialization data for the various applications and background processes.

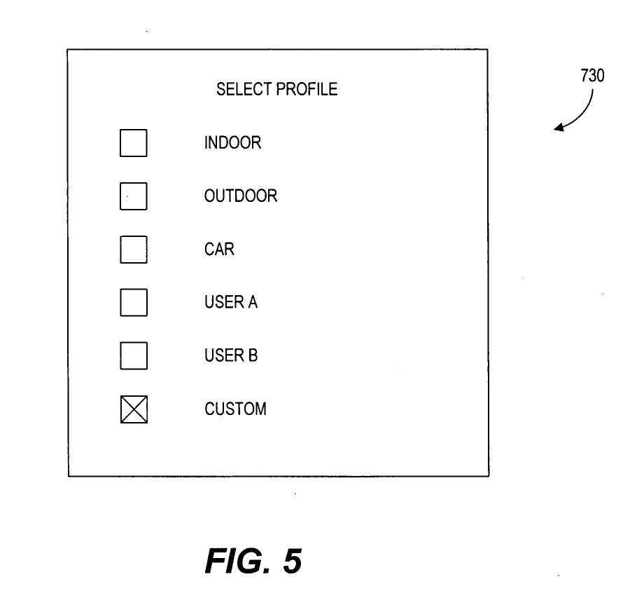

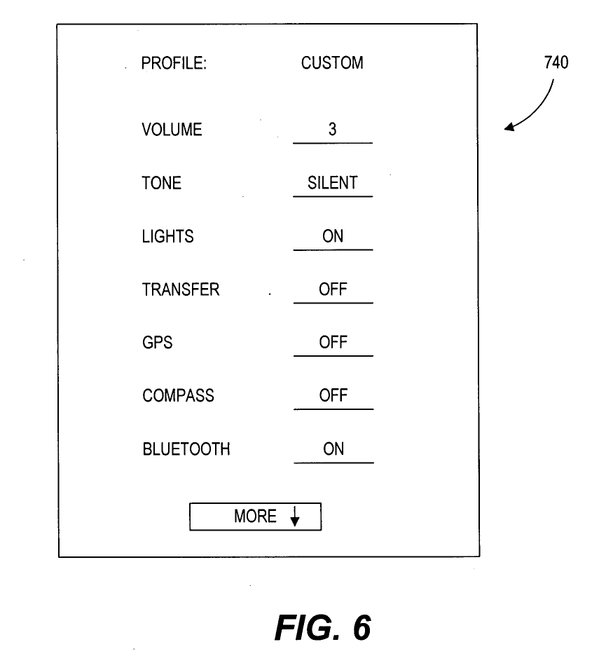

Referring now to FIG. 3, the management of the profiles will now be described. A profiles user interface 110 is provided to allow a user to select, modify, add, delete or otherwise customize a profile. The profiles interface 110 may provide a user with a graphical display, as exemplarily illustrated and described below with reference to FIGS. 5 and 6. The profiles user interface 110 interacts with various modules of the device to provide an appropriate display to the user. Further, the profiles user interface 110 communicates inputs from the user to the appropriate system module. Some of the various modules 310, 320, 330, 420, 220, 230, 240, 250, 410 are illustrated in FIG. 3 and described below. In a particular embodiment, the profiles user interface 110 is divided into a profiles interface module and a profile dialog module. In this regard, the profile dialog module may be launched from other applications through a notifier framework. Further, the profiles user interface 110 may include the profiles module described above to store on or more profiles indicating background processes to be started.

The profiles user interface 110 communicates with a platform-specific UI library 310 which contains platform-specific implementations of graphical components. In this regard, the platform-specific UI library 310 enables the profiles user interface 110 to present the appropriate graphic display to the user based on the current platform or device. The platform-specific UI library 310 may reside in the UI frameworks module 300 shown in FIG. 1.

A skin framework module 320 may provide one or more changeable graphical layers on top of the user interface presented to the user. The skin framework module 320 may define layouts and components for a specified visual appearance. The skin framework module 320 may also reside in the UI frameworks module 300 shown in FIG. 1.

A touch screen and keypad lock module 330 may be provided to lock or unlock the keypad or touch screen input. The touch screen and keypad lock module 330 may also reside in the UI frameworks module 300 shown in FIG. 1.

An applications engines module 130, residing in the application user interfaces module 100 of FIG. 1, may be provided for supporting various applications. The application engines module 120 may include API's to provide access to the application data of the core applications. The API's allow third-party applications to integrate with core applications.

The profiles user interface 110 may communicate with various modules residing in the common components and applications services module 200 of FIG. 1, including the core services module 220 (also shown in FIG. 2) and an application services module 260. The application services module 260, as described in the context of FIG. 1, may include an alarm server, a logging engine, a system-wide task scheduler, a system agent, and converters between various data and standards formats.

Additionally, a DRM engines module 230 is accessed by the profiles user interface 110 to provide management of various rights and keys. For example, the DRM engines module 230 provide support for encrypting and decrypting content.

A telephony security module 240, in the context of mobile phones, is provided to control and manage security relating to various applications. For example, the telephony security module 240 may manage access and data relating to the use of personal identification numbers (PIN).

A multimedia UI module 250 containing platform-specific application user interfaces may be accessed by the profiles user interface 110. This module 250 may provide support for specific functionality of various applications, as required by UI layers.

FIG. 4 illustrates a profile table according to an embodiment of the invention. In one embodiment, a profiles module may store each of a plurality of profiles 701-706, with each profile defining settings for a plurality of conditions. The conditions may include operating characteristics 710 and services 720.

In regard to the services 720, each profile 701-706 includes a status of the service 720 as either “On” or “Off”. This status indicates whether or not the user desires the capability for that service. Thus, if the user is in an office environment, the “Indoor” profile 701 may be selected. In this regard, the user has selected Bluetooth and WLAN, while GPS and Compass capabilities are deselected. On the other hand, if the user is in a remote region, the “Outdoor” profile 702 may be selected to provide the user with GPS and Compass capability while deselecting Bluetooth and WLAN.

Referring now to FIGS. 5 and 6, the management of a profile, including services requiring background processes to be started during boot up, from a user's perspective will now be described. When a user desires to customize, update a profile or select or deselect a service, the user may access the a profile menu through, for example, a menu tree using a keypad or a touch screen, as commonly available on many devices. Once the profile menu has been accessed by the user, the user may be presented with a display of options, such as those illustrated in the exemplary screen shot 730 of FIG. 5. In this example, the user is offered a selection of profiles to choose from. For example, a “CUSTOM” profile may be provided (currently selected in FIG. 5) that may correspond to the settings corresponding to the “Custom” profile 706 shown in FIG. 4.

Alternate profiles may be offered as options in the profile menu. The alternate profiles may include one or more factory-installed profiles which corresponding to various groups of features. For example, the “User B” profile 705 may be provided to include minimal features and service 720 and, therefore, the fastest boot up, while the “User A” profile may be provided with all services 720 selected to provide maximum functionality to the user. Additional options may include profiles previously created by the user, such as “Indoor” and “Outdoor”.

An option may be provided to allow the user to create a new, customized profile. In FIG. 5, this option is presented to the user as “CUSTOM”. When a user selects this option, the user may be presented with a screen shot, as shown in FIG. 6, which provides the user with an option to select or de-select any feature or group of features in the device. The user may first be presented with a list of all features, in addition to various operating characteristics, available on the device, with selections corresponding to the current configuration. Thus, in the example of FIG. 6, the user may be presented with a screen showing that the Bluetooth feature has been selected, while the GPS and Compass features have been de-selected. The user may scroll up and down to review, select or de-select each feature in the list, in addition to adjusting operating characteristics such as volume and ring tone. When the user has completed the selection and de-selection of features, the profile may be stored in the profiles module described above, and the profile may be presented to the user in the list shown in FIG. 5 as an option.

Thus, if the current active profile is the “User A” profile, when the user changes to the “Custom” profile, in addition to changes in the operating characteristics 710, certain services 720 may be deselected and disabled. For example, in the embodiment illustrated in FIG. 4, the GPS and Compass services are disabled. When the user re-boots the device, background processes related to the GPS and Compass services are not started, resulting in faster boot up and more available memory.

In one embodiment, the boot up of a device uses the profile which was last active when the device was shut down. Once boot-up is completed, the availability of services may be controlled by changing profiles. Thus, services may be started or stopped when a profile is changed. In certain embodiments, when a user changes profiles, the selected services may not become available until the device is re-booted. For example, if the current profile is the “Custom” profile and the user changes to the “Car” profile, the GPS service may not be immediately available since the background processes required for that service have not been started. Thus, when the device is re-booted, the device start-up manager accesses the “Car” profile and starts background processes relating to the Bluetooth and GPS services.

It is important to note that the features that are available for the user to select or de-select may not include certain features which are necessary for the device to operate. Thus, even if the user de-selects all features presented, the device can still operate properly.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

1. An electronic device, comprising:
a profiles module adapted to store one or more profiles, each of said profiles being indicative of a set of features, at least one of said profiles being customizable by a user and having at least one feature being a service associated with a background process.

2. The device of claim 1, further comprising:
a startup manager adapted to start a set of background processes during a boot up of the device, said set of background processes corresponding to said set of features of a selected one of said profiles.

3. The device of claim 1, further comprising:
a user interface module adapted to receive inputs from a user, said inputs being associated with a selection or deselection of one or more of said features.

4. The device of claim 1, wherein said features include non-telephony services.

5. The device of claim 1, wherein said device is a wireless device.

6. The device of claim 1, wherein said device is a mobile phone.

7. The device of claim 1, wherein said profiles module includes a user interface adapted to allow a user to select one of said profiles.

8. The device of claim 1, wherein said user interface is adapted to allow a user to select one or more features to include in said customized profile.

9. A method of managing an electronic device, comprising:
accessing a selected profile in a profile module having one or more profiles therein, each of said profiles being indicative of a set of features, at least one of said profiles being customizable by a user and having at least one feature being a service associated with a background process; and
starting a set of background processes during a boot up of a device, said set of background processes corresponding to said set of features of said selected profile.

10. The method of claim 9, wherein said device is a wireless device.

11. The method of claim 9, wherein said device is a mobile phone.

12. The method of claim 9, wherein said profiles module includes a user interface adapted to allow a user to select one of said profiles.

13. The method of claim 9, wherein said profiles module includes a user interface adapted to allow a user to create a customized profile.

14. The method of claim 13, wherein said user interface is adapted to allow a user to select one or more features to include in said customized profile.

15. A program product, comprising machine readable program code for causing a machine to perform the following method steps:
accessing a selected profile in a profile module having one or more profiles therein, each of said profiles being indicative of a set of features, at least one of said profiles being customizable by a user; and
starting a set of background processes during a boot up of a device, said set of background processes corresponding to said set of features of said selected profile.

16. The program product of claim 15, wherein said device is a wireless device.

17. The program product of claim 15, wherein said device is a mobile phone.

18. The program product of claim 15, wherein said profiles module includes a user interface adapted to allow a user to select one of said profiles.

19. The program product of claim 15, wherein said profiles module includes a user interface adapted to allow a user to create a customized profile.

20. The program product of claim 19, wherein said user interface is adapted to allow a user to select one or more features to include in said customized profile.

21. A method of managing an electronic device, comprising:
storing a profile in a profiles module, said profile being indicative of a set of user-selected features, at least one of said features being a service associated with a background process; and
starting a set of background processes during a boot up of a device, said set of background processes corresponding to said set of features of said stored profile.

22. A method of managing an electronic device, comprising:
presenting a set of features to a user, at least one of said features being customizable by a user and being a service associated with a background process; and
receiving inputs from a user, said inputs being associated with a selection or deselection of one or more of said features.
